(19) United States
(12) Patent Application Publication
(10) Pub. No.: US 2005/0016055 A1
(43) Pub. Date: Jan. 27, 2005

(54) Pest inspection system and method of conducting an inspection

(76) Inventor: Mark Leslie Moyle, Canning Vale (AU)

Correspondence Address: SHAW PITTMAN LLP, 1650 TYSONS BOULEVARD, MCLEAN, VA, 22102, US

(21) Appl. No.: 10/805,367

(22) Filed: Mar. 22, 2004

(30) Foreign Application Priority Data
Apr. 28, 2003 (AU) 2003-901998

(51) Int. Cl. A01M 1/20

(52) U.S. Cl. 43/132.1

(57) ABSTRACT

A pest inspection system comprising at least one inspection station positioned about a predefined inspection area and a central administrator. In response to a periodic reminder issued by the central administrator, a person manually inspects each inspection station about the predefined inspection area for signs of pest infestation. Each inspection station comprises a housing having a transparent portion on at least one side thereof. The housing is able to receive a pest attractant or food source. The housing also has openings therein to allow a pest to access the area where the pest attractant or food source is able to be received. In this manner, the person can inspect any received pest attractant or food source via the transparent portion of the housing.

### FIELD OF THE INVENTION

The present invention relates to a pest inspection system and method of conducting an inspection. In particular, the invention is directed towards a self-inspection system with on-going support being provided by a pest controller.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The following discussion of the background to the invention is intended to facilitate an understanding of the present invention. However, it should be appreciated that the discussion is not an acknowledgement or admission that any of the material referred to was published, known or part of the common general knowledge in any jurisdiction as at the priority date of the application.

Typically, pest inspections are conducted by pest control professionals. Some systems are available that allow people other than pest control professionals to perform pest inspections. However, such systems are typically sold on an “off-the-shelf” basis and, thus, the purchaser typically does not receive the support of a pest controller.

It is an object of the present invention to provide a “do-it-yourself” pest inspection system, where the purchaser of the system receives ongoing support from a pest controller. It is a supplementary, but not mandatory, object of the present invention that the on-going support from a pest controller take the form of inspection reminders and/or provision of advice on eradication of the pest upon detection.

### DISCLOSURE OF THE INVENTION

In accordance with a first aspect of the invention there is a pest inspection system comprising:
at least one inspection station positioned about a predefined inspection area; and
a central administrator,
   where, in response to a periodic reminder issued by the central administrator, a person manually inspects each inspection station about the predefined inspection area for signs of pest infestation.

Preferably, the central administrator includes at least one pest control professional and the person contacts the at least one pest control professional upon detecting signs of pest infestation, the at least one pest control professional thereafter providing advice to the person on how to deal with the pest infestation. The pest control professional may advise of additional services provided by the cental administrator for dealing with the pest infestation and/or upgraded pest inspection systems provided by the central administrator. If the person decides to obtain such additional services and/or an upgraded pest inspection system, the central administrator may apply either a predetermined discount or refund to the cost of obtaining the additional services or upgraded pest inspection system, as appropriate.

The central administrator may apply a further predetermined discount or refund to the cost of obtaining an upgraded pest inspection system if the person gives the original pest inspection system to a third party and notifies the central administrator of the transfer.

Preferably, the central administrator stores a predetermined set of details obtained from the person regarding the pest infestation in a database. The central administrator can then perform a geographical analysis of a region based on details stored in the database. If the geographical analysis predicts a regional pest infestation, the central administrator contacts the owners of other properties in the analysed region informing them of the predicted regional pest infestation.

More preferably, the inspection station comprises a housing having a transparent portion on at least one side thereof, the housing containing a pest attractant or food source, and having openings therein to allow the pest to access the pest attractant or food source, whereby the person can inspect the pest attractant or food source via the transparent portion. Ideally, each inspection station is spaced from each other inspection site by a distance of between 3 and 4 metres.

Preferably, if the person does not detect signs of pest infestation, the person sends an acknowledgment of the periodic reminder to the central administrator. Details of the acknowledgment may be stored in the database so that the central administrator can provide an inspection history report based on details stored in the database to the person on request.

Acknowledgment of the periodic reminder may take one of the following forms; a facsimile; an e-mail; a telephone call; a postal communication; a web-site notice; a Short Message Service message.

Ideally, the predefined area includes a residential premises occupied by the person and the periodic reminder is issued monthly. The periodic reminder may also take one of the following forms: a facsimile; an e-mail; a telephone call; a postal communication; a web-site notice; a Short Message Service message.

In accordance with a second aspect of the present invention there is an inspection station for use in a pest inspection system, comprising a housing having a transparent portion on at least one side thereof, the housing able to receive a pest attractant or food source, and having openings therein to allow a pest to access the area where the pest attractant or food source is able to be received, whereby, the person can inspect any received pest attractant or food source via the transparent portion.

Preferably, the housing comprises an open-ended central body and a cap adapted to cover an open end of the central body, at least one portion of the cap being transparent. More preferably, the cap has a threaded portion and the central body has a threaded portion at one open end for securely engaging the threaded portion of the cap thereon.

Alternatively, the cap is of slightly smaller size that an open end of the central body, such that the insertion of the cap into the end of the central body securely engages the cap to the central body.

In yet a further alternative arrangement, the cap has a rim around its perimeter and is of slightly greater size than the central body, such that insertion of the cap into the area bounded by the rim securely engages the central body to the cap.

The latter two arrangements are referred to later in the specification as “close fit” arrangements.

Preferably, the cap further comprises retaining means for retaining any received pest attractant or food source within the central body. The retaining means may take the form of a plurality of inwardly projecting teeth. Ideally, the cap is substantially cylindrical with an open end, and the plurality of inwardly projecting teeth are radially disposed about the wall of the cylinder.

Preferably, the open-ended central body has a snap-off flange adjacent one open end thereof. Further, the openings are transverse slits and the housing is a cylinder.

In accordance with a third aspect of the present invention there is a central administrator for use in a pest inspection system comprising at least one inspection station positioned about a predefined inspection area, where the central administrator issues periodic reminders to a person who, in response to the periodic reminders, manually inspects each inspection station about the predefined inspection area for signs of pest infestation.

Preferably, the central administrator includes at least one pest control professional, the person acting to contact the at least one pest control professional upon detecting signs of pest infestation, the at least one pest control professional thereafter providing advice to the person on how to deal with the pest infestation. The pest control professional may advise of additional services provided by the central administrator for dealing with the pest infestation and/or upgraded pest inspection systems provided by the central administrator and, where, if the person decide to obtain such additional services and/or an upgraded pest inspection system, the central administrator applies either a predetermined discount or refund to the cost of obtaining the additional services or upgraded pest inspection system, as appropriate. The central administrator may apply a further predetermined discount or refund to the cost of obtaining an upgraded pest inspection system if the person gives the original pest inspection system to a third party and notifies the central administrator of the transfer.

Preferably, the central administrator includes a database for storing a predetermined set of details obtained from the person regarding the pest infestation. The central administrator can then perform a geographical analysis of a region based on details stored in the database and, if the geographical analysis predicts a regional pest infestation, operable to contact the owners of other properties in the analysed region informing them of the predicted regional pest infestation.

The central administrator is operable to receive an acknowledgment from the person where said person does not detect signs of pest infestation and store details of said acknowledgment in the database and where, upon request of the person, the central administrator is operable to produce and provide an inspection history report based on details stored in the database to the person. The central administrator may issue the periodic reminder on a monthly basis.

The central administrator may Issue the periodic reminder in one of the following forms: a facsimile, an e-mail; a telephone call; a postal communication; a web-site notice; a Short Message Service message.

In accordance with a fourth aspect of the present invention there is a method of conducting a pest inspection comprising sending a periodic reminder to a person who manually inspects at least one inspection station positioned about a predefined inspection area for signs of pest infestation.

Preferably, the method includes the step of installing the at least one inspection station about a predefined inspection area.

More preferably, the method includes the steps of receiving a communication from the person on detecting signs of pest infestation and providing advice to the person on how to deal with the pest infestation. The method may also include the steps of advising the person of additional services available for dealing with the pest infestation and/or upgraded pest inspection systems, and, if the person decide to obtain such additional services and/or an upgraded pest inspection system, applying a predetermined discount or a refund to the cost of obtaining the additional services or upgraded pest inspection system, as appropriate.

Preferably, the method includes the steps of receiving notification from the person of a transfer of the original pest inspection system to a third party and applying a further predetermined discount or refund to the cost of obtaining an upgraded pest inspection system by the person. More preferably, the method includes the step of storing a predetermined set of details obtained from a person regarding the pest infestation in a database.

Preferably, the method includes the steps of performing a geographical analysis of a region based on details stored in the database; and, if the geographical analysis predicts a regional pest infestation, contacting the owners of other properties in the analysed region informing them of the predicted regional pest infestation.

More preferably, the method includes the step of spacing each inspection station from each other by a distance of between 3 and 4 metres prior to installation.

Preferably, the method includes the step of receiving an acknowledgment of the periodic reminder from the person when the person does not detect signs of pest infestation. The method may also include the steps of storing details of the acknowledgment in the database and providing an inspection history report based on details stored in the database on request of the person.

### BRIEF DESCRIPTION OF THE DRAWINGS

The invention will now be described, by way of example only, with reference to the accompanying drawings, of which:

FIG. 1 is a schematic representation of the pest inspection system.

FIG. 2 is a plan view of a central body of an inspection site.

FIG. 3 is a cross sectional view of a central body of an inspection site.

FIG. 4 is a top plan view of a central body of an inspection site.

FIG. 5 is plan schematic view of a cap of an inspection site, the cap securely retaining a piece of timber therein.

FIG. 6 is an isometric schematic view of a cap of an inspection site, the cap securely retaining a piece of timber therein.

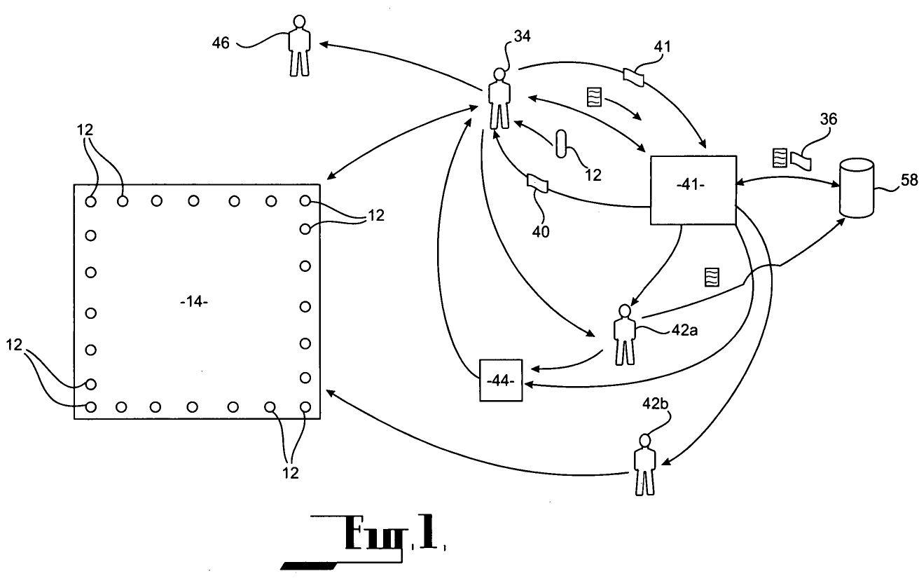

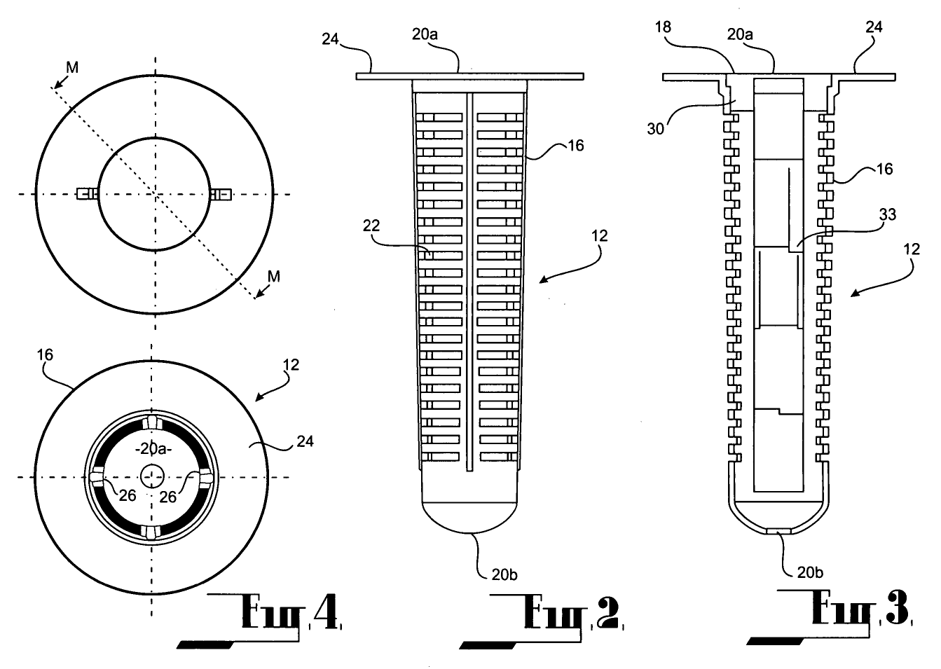

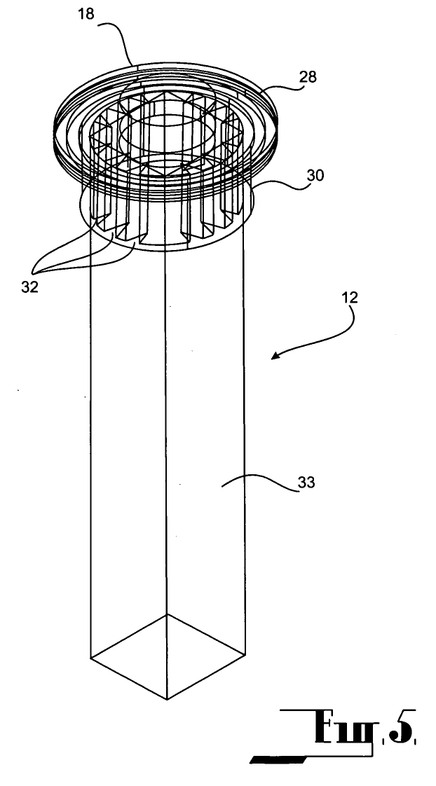

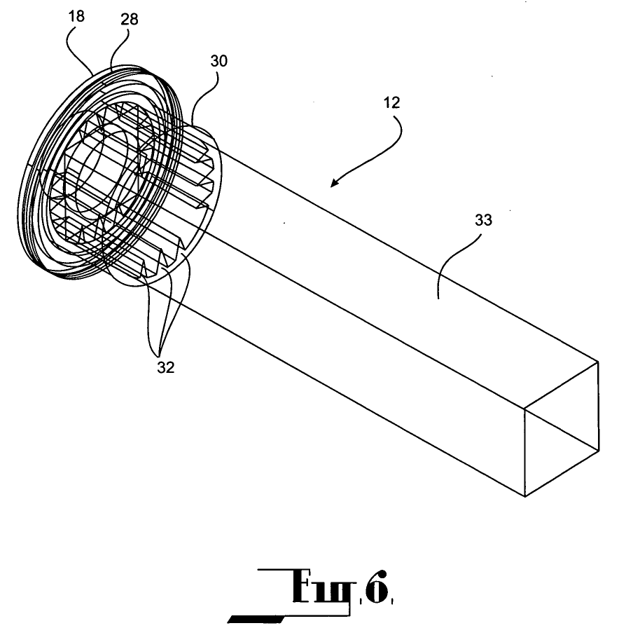

### BEST MODE(S) FOR CARRYING OUT THE INVENTION

The embodiment of the invention described below will be made with reference to an inspection for termite infestations. However, it should be remembered that the concepts behind this system are not limited to use in inspecting premises for termites.

In a first embodiment of the invention there is a pest inspection system 10. The pest inspection system 10 uses a plurality of inspection stations 12. Inspection stations 12 are placed into the ground about a predefined inspection area 14 at a distance of approximately 3 to 4 metres to each other.

Each inspection station 12 comprises a hollow 12″ cylinder 16 and a cap 18. The cylinder 16 is open at both ends 20a, 20b and has transverse slits 22 provided therein. Surrounding end 20a is a flange 24. Flange 24 can be permanently detached from the cylinder 16 by applying substantial pressure against the flange 24 in a direction opposite to the application of pressure applied to the cylinder 16, ie. the flange 24 and the cylinder 16 are in a snap-off arrangement.

Flange 24 has two access points 26 therein. These access points 26 allow the cap 18 to be removed from the cylinder 16 when retained therein.

The cap 18 consists of a circular face 28 and is made of a transparent material. A circular wall 30 of smaller diameter protrudes from the circular face 28. Radially disposed about the circular wall 30 are teeth 32. Teeth 32 project inward towards the centre of the area bound by the circular wall 30.

This arrangement of teeth 32 act to securely retain a piece of wood 33 within the cylinder 16. However, the arrangement also allows the piece of wood 33 to be easily removed from the cylinder 16 as required.

Ideally, each inspection station 12 is positioned such that the cap 18 is substantially flush with the surrounding inspection area 14. In this manner, the inspection station 12 is limited as an obstruction of the surrounding inspection area 14 as well as reducing the danger of the inspection station 12 as a tripping hazard. Snapping off the flange 24 can further limit the inspection station 12 as an obstruction and a tripping hazard.

In use, the owner 34 of the inspection area 14 or such other person as may be designated by the owner 34 of the inspection area 14, will purchase a number of inspection stations 12 from a central administrator, such as pest control company 36, and sign-up to be part of their pest inspection system 10.

The sign-up process requires the owner 34, or such other person, to provide contact details to the pest control company 36, namely:
an e-mall address;
a telephone number;
a contact address; and
details of the proposed physical location of the inspection stations 12 or inspection area 14, such as a home or business address.

These details are stored in a database 38 administered by the pest control company 36.

Inspection stations 12 are then sent to the owner 34, or such other person, at the designated contact address. The owner 34, or such other person, is then responsible for installing the inspection stations 12 about the inspection area 14.

As mentioned above, ideally the owner 34, or such other person, installs each inspection station 12 such that the cap 18 is flush with the surrounding portions of the inspection area 14. Further, each inspection station 12 should be spaced approximately 3 to 4 metres from each other inspection station 12.

This spacing of inspection stations 12 at a distance of approximately 3 to 4 metres is important, but not essential. When foraging for food, termites wander in random directions. However, from experience, it has been determined that placing inspection stations 12 at 3 to 4 metre intervals ensures that there is a high degree of possible entry into the inspection station by the random foraging of the termite.

The pest control company 36, will issue periodic reminders 40 to the owner 34, or such other person, care of the e-mail address provided at the time of sign-up. Typically, the periodic reminder 40 will be sent monthly and will instruct the owner 34, or such other person, to check each inspection site 12 for termite infestation. Inspection is then carried out by the owner 34, or such other person, checking to see whether the piece of wood 32 has been eaten away, in whole or in part, by termites. The transparent plastic used to create the cap 18 allows this inspection to be carried out without need to remove the piece of wood 32 or otherwise interact with the inspection station 12.

If the inspection reveals a termite infestation at an inspection station 12, the owner 34, or such other person, can contact a qualified pest control professional 42a for advice. The method of contact may be by e-mail or by telephone, such as a Telstra™ 1800 Freecall number.

If the inspection does not reveal a termite infestation at any inspection station 12, the owner 34, or such other person, is requested to respond to the periodic reminder 40. In this manner, the response 41 to the periodic reminder 40 acts as an acknowledgment to the pest control company 36 that the inspection has been carried out by the owner 34, or such other person.

If contacted, the pest control professional 42a will provide information on how to respond to the termite infestation. This advice may suggest the need for on-site assistance by a pest control professional 42b of the pest control company 36, particularly in situations where chemical eradication of the termite infestation is required. The pest control professional's 42a advice may also be to upgrade the pest inspection system 10 to a system 44 monitored by the pest control company 36.

If the owner 34, or such other person, accepts the pest control professional's 42a advice to obtain an upgraded system 44 or additional services from the pest control company 36, the pest control company 36 will refund to the owner 34, or such other person, the cost of purchasing the pest inspection system 10. Alternatively, the pest control company 36 may offer a discount on the upgraded system 44 or additional services.

If the owner 34, or such other person, obtains an upgraded system 44, the pest inspection system 10 may be transferred to another person 46. In such situations, the pest control company 36 is to be notified of the transfer and the original owner 34, or such other person, may be provided with an additional discount on the upgraded system 44.

The database 38 is also used for event recording. Thus, whenever the owner 34, or such other person, contacts pest control professional 42a, details of the problem described by the owner 34, or such other person, and the advice given in response to the problem by the pest control professional 42a is recorded with the database 38. The database 38 also records responses 41 to the periodic reminder 40 acknowledging that the inspection has been carried out.

Both types of information are associated against the inspection area 14 and owner 34, or such other person, designated at the time of sign-up for the pest inspection system 10. As the implementation of such a database 38 would be understood by the person skilled in the art, it will not be described in more detail here.

The database 38 can then be used to track trends in a geographical area, such as a frequent occurrence of termite infestations, and thereby warn other residents of the geographical area that their homes or premises may also be infested with termites. Similarly, if the owner 34, or such other person, has responded to each periodic reminder 40 without contacting the pest control professional 42a, and thereby indicating that inspections have been carried out without trace of termite infestation, on sale of land or premises within the inspection area 14, the pest control company 36 may, subject to local legislation and appropriate disclaimers, be in a position to provide a certificate verifying the land or premises to be free of termites. Alternatively, the pest control company 36 may provide a certificate confirming when the system was installed and a historical record of each inspection and its results.

It should be appreciated by the person skilled in the art that the invention is not limited to the above embodiment. In particular,
the periodic reminder may be by means of facsimile, telephone call SMS message, or via forms or applets on a web-site (referred to in this specification as a “web-site notice”) or any other means of communication instead of by e-mail;
the cap 18 may be made substantially of an opaque material with a portion thereof being made of a transparent material, the piece of wood 33 being able to be inspected via the transparent material without need to remove cap 18;
the means of securing the cap 18 with the cylinder 16 may be by means of a threading arrangement or by means of “close-fit” arrangements;
the means of retaining the piece of wood 33 in the cylinder may be attained by other retaining mechanisms such as clips.
the piece of wood 33 may be replaced with another food source or pest attractant for the pest to which the pest inspection system 10 is directed to; and
the cylinder 16 may be of variable length.
The inspection station 12 need not be designed to sit flush with the ground. In such an arrangement, the cap 18 may be opaque. Instead, a portion of a side of the cylinder 16 may be transparent to facilitate inspection of the food source or pest attractant without need to remove the food source of pest attractant or otherwise interact with the inspection site.

It should be further appreciated by the person skilled in the art that variations and combinations of features described above, not being alternatives or substitutes, can be combined to form yet further embodiments falling within the intended scope of the invention.

1. A pest inspection system comprising:
at least one inspection station positioned about a predefined inspection area; and
a central administrator,
where, in response to a periodic reminder issued by the central administrator, a person manually inspects each inspection station about the predefined inspection area for signs of pest infestation.

2. A pest inspection system according to claim 1, where the central administrator includes at least one pest control professional and the person contacts the at least one pest control professional upon detecting signs of pest infestation, the at least one pest control professional thereafter providing advice to the person on how to deal with the pest infestation.

3. A pest inspection system according to claim 2, where the pest control professional advises of additional services provided by the central administrator for dealing with the pest infestation and/or upgraded pest inspection systems provided by the central administrator and, where, if the person decides to obtain such additional services and/or an upgraded pest inspection system, the central administrator applies either a predetermined discount or refund to the cost of obtaining the additional services or upgraded pest inspection systems, as appropriate.

4. A pest inspection system according to claim 3, where the central administrator applies a further predetermined discount or refund to the cost of obtaining an upgraded pest inspection system if the person gives the original pest inspection system to a third party and notifies the central administrator of the transfer.

5. A pest inspection system according to, claim 1 where the central administrator stores a predetermined set of details obtained from the person regarding the pest infestation in a database.

6. A pest inspection system according to claim 5, where the central administrator can perform a geographical analysis of a region based on details stored in the database and, if the geographical analysis predicts a regional pest infestation, the central administrator contacts the owners of other properties in the analyzed region informing them of the predicted regional pest infestation.

7. A pest inspection system according to, claim 1 where the inspection station comprises a housing having a transparent portion on at least one side thereof, the housing containing a pest attractant or food source, and having openings therein to allow the pest to access the pest attractant or food source, whereby the person can inspect the pest attractant or food source via the transparent portion.

8. A pest inspection system according to, claim 1 where each inspection station is spaced from each other inspection site by a distance of between 3 and 4 meters.

9. A pest inspection system according to, claim 1 where if the person does not detect signs of pest infestation, the person sends an acknowledgment of the periodic reminder to the central administrator.

10. A pest inspection system according to claim 9, where details of the acknowledgment are stored in the database and where the central administrator can provide an inspection history report based on details stored in the database to the person on request.

11. A pest inspection system according to claim 9, where the acknowledgment of the periodic reminder takes one of the following forms; a facsimile; an e-mail; a telephone call; a postal communication; a web-site notice; a Short Message Service message.

12. A pest inspection system according to claim 11, where the acknowledgment of the periodic reminder takes the form of a web-site notice.

13. A pest inspection system according to, claim 1 where the predefined area includes a residential premises occupied by the person.

14. A pest inspection system according to, claim 1 where the periodic reminder is issued monthly.

15. A pest inspection system according to, claim 1 where the periodic reminder takes one of the following forms: a facsimile; an e-mail; a telephone call; a postal communication; a web-site notice; a Short Message Service message.

16. A pest inspection system according to claim 15, where the periodic reminder takes the form of a telephone call.

17. An inspection station for use in a pest inspection system, comprising a housing having a transparent portion on at least one side thereof, the housing able to receive a pest attractant or food source, and having openings therein to allow a pest to access the area where the pest attractant or food source is able to be received, whereby, the person can inspect any received pest attractant or food source via the transparent portion.

18. An inspection station according to claim 17, where the housing comprises an open-ended central body and a cap adapted to cover an open end of the central body, at least one portion of the cap being transparent.

19. An inspection station according to claim 18, where the cap has a threaded portion and the central body has a threaded portion at one open end for securely engaging the threaded portion of the cap thereon.

20. An inspection station according to claim 18, where the cap is of slightly smaller size that an open end of the central body, such that the insertion of the cap into the end of the central body securely engages the cap to the central body.

21. An inspection station according to claim 18, where the cap has a rim around its perimeter and is of slightly greater size than the central body, such that insertion of the cap into the area bounded by the rim securely engages the central body to the cap.

22. An inspection station according to, claim 18 where the cap further comprises retaining means for retaining any received pest attractant or food source within the central body.

23. An inspection station according to claim 22, where the retaining means is a plurality of inwardly projecting teeth.

24. An inspection station according to claim 23, where the cap is substantially cylindrical with an open end, and the plurality of inwardly projecting teeth are radially disposed about the wall of the cylinder.

25. An inspection station according to, claim 18 where the open-ended central body has a snap-off flange adjacent one open end thereof.

26. An inspection station according to, claim 17 where the openings are transverse slits.

27. An inspection station according to, claim 17 where the housing is a cylinder.

28. A central administrator for use in a pest inspection system comprising at least one inspection station positioned about a predefined inspection area, where the central administrator issues periodic reminders to a person who, in response to the periodic reminders, manually inspects each inspection station about the predefined inspection area for signs of pest infestation.

29. A central administrator according to claim 28, including at least one pest control professionals, the person acting to contact the at least one pest control professional upon detecting signs of pest infestation, the at least one pest control professional thereafter providing advice to the person on how to deal with the pest infestation.

30. A central administrator according to claim 29, where the pest control professional advises of additional services provided by the central administrator for dealing with the pest infestation and/or upgraded pest inspection systems provided by the central administrator and, where, if the person decide to obtain such additional services and/or an upgraded pest inspection system, the central administrator applies either a predetermined discount or refund to the cost of obtaining the additional services or upgraded pest inspection system, as appropriate.

31. A central administrator according to claim 30, where the central administrator applies a further predetermined discount or refund to the cost of obtaining an upgraded pest inspection system if the person gives the original pest inspection system to a third party and notifies the central administrator of the transfer.

32. A central administrator according to, claim 28 including a database for storing a predetermined set of details obtained from the person regarding the pest infestation.

33. A central administrator according to claim 32, operable to perform a geographical analysis of a region based on details stored in the database and, if the geographical analysis predicts a regional pest infestation, operable to contact the owners of other properties in the analyzed region informing them of the predicted regional pest infestation.

34. A central administrator according to claim 32, operable to receive an acknowledgment from the person where said person does not detect signs of pest infestation and store details of said acknowledgment in the database and where, upon request of the person, the central administrator is operable to produce and provide an inspection history report based on details stored in the database to the person.

35. A central administrator according to, claim 28 operable to issue the periodic reminder on a monthly basis.

36. A central administrator according to, claim 28 operable to issue the periodic reminder in one of the following forms: a facsimile, an email; a telephone call; a postal communication; a web-site notice; a Short Message Service message.

37. A central administrator according to claim 36, operable to issue the periodic reminder in the form of a telephone call.

38. A method of conducting a pest inspection comprising sending a periodic reminder to a person who manually inspects at least one inspection station positioned about a predefined inspection area for signs of pest infestation.

39. A method of conducting a pest inspection according to claim 38, including the step of installing the at least one inspection station about a predefined inspection area.

40. A method of conducting a pest inspection according to claim 38, including the steps of receiving a communication from the person on detecting signs of pest infestation and providing advice to the person on how to deal with the pest infestation.

41. A method of conducting a pest inspection according to claim 40, including the step of advising the person of additional services available for dealing with the pest infestation and/or upgraded pest inspection systems, and, if the person decide to obtain such additional services and/or an upgraded pest inspection system, applying a predetermined discount or a refund to the cost of obtaining the additional services or upgraded pest inspection system, as appropriate.

42. A method of conducting a pest inspection according to claim 41, including the steps of receiving notification from the person of a transfer of the original pest inspection system to a third party and applying a further predetermined discount or refund to the cost of obtaining an upgraded pest inspection system by the person.

43. A method of conducting a pest inspection according to, claim 38 including the step of storing a predetermined set of details obtained from a person regarding the pest infestation in a database.

44. A method of conducting a pest inspection according to claim 42, including the steps of performing a geographical analysis of a region based on details stored in the database; and, if the geographical analysis predicts a regional pest infestation, contacting the owners of other properties in the analyzed region informing them of the predicted regional pest infestation.

45. A method of conducting a pest inspection according to claim 39, including the step of spacing each inspection station from each other by a distance of between 3 and 4 meters prior to installation.

46. A method of conducting a pest inspection according to, claim 38 including the step of receiving an acknowledgment of the periodic reminder from the person when the person does not detect signs of pest infestation.

47. A method of conducting a pest inspection according to claim 46, including the steps of storing details of the acknowledgment in the database and providing an inspection history report based on details stored in the database on request of the person.

48. (Canceled)

49. (Canceled)

50. (Canceled)

51. (Canceled)
